(19) United States
(12) Patent Application Publication
(10) Pub. No.: US 2026/0024871 A1
(43) Pub. Date: Jan. 22, 2026

(54) SECONDARY BATTERY

(71) Applicant: Prime Planet Energy & Solutions, Inc., Tokyo (JP)

(72) Inventor: Satoshi FUJIMURA, Toki-shi (JP)

(21) Appl. No.: 19/220,089

(22) Filed: May 28, 2025

(30) Foreign Application Priority Data
Jul. 18, 2024 (JP) 2024-114957

(51) Int. Cl. H01M 50/342

(52) U.S. Cl. CPC H01M 50/3425

(57) ABSTRACT

A sealed secondary battery includes a battery case, an electrode body hermetically housed in the battery case, an insulating member interposed between the battery case and the electrode body, and a safety valve provided in the battery case at a position facing the insulating member to release gas out of the battery case when gas pressure or temperature in the battery case rises to a predetermined value or higher. The safety valve includes an openable valve part and a valve-part supporting portion annularly supporting the outer circumferential portion of the valve part and connected to the battery case. A case inner surface of the valve-part supporting portion, located inside relative to the valve part, is provided with a gas-passage forming portion that forms a gas passage communicating toward the valve part between the insulating member pushed toward the valve part by the gas and the valve-part supporting portion.

### CROSS-REFERENCE TO RELATED APPLICATIONS

This application is based upon and claims the benefit of priority to Japanese Patent Application No. 2024-114957 filed on Jul. 18, 2024, the entire contents of which are incorporated herein by reference.

### BACKGROUND

### Technical field

The disclosure relates to a secondary battery.

### Related Art

In a sealed secondary battery with an electrode body housed in a battery case, generally, gas may be generated as the battery temperature rises, for example, when the secondary battery is charged at high voltage or high current, and the pressure or temperature of the gas in the battery case may increase to a predetermined value or higher. Accordingly, many sealed secondary batteries are each provided with a safety valve in the battery case to release gas from inside to outside of the battery case when the gas pressure or gas temperature in the battery case rises to the predetermined value or higher. For a battery case made of metal, it is further known to interpose an insulating member between the electrode body and the battery case in order to enhance electrical insulation between the electrode body and the battery case.

For example, Japanese unexamined patent application publication No. 2020-095836 (JP 2020-095836A) discloses a secondary battery configured such that a lid member of a battery case is provided with a safety valve, and an end portion of an insulating film (an insulating member) interposed between an electrode body and the battery case extends toward the lid member. Further, Japanese unexamined patent application publication No. 2004-031263 (JP 2004-031263A) discloses a battery configured such that a group of electrodes is housed in a bottomed rectangular prismatic battery case, a negative electrode lead continuous with a negative electrode plate is electrically connected to an inner terminal of a sealing member having a safety valve via an upper insulating plate (an insulating member), and the upper insulating plate extends so as to cover over the safety valve.

### SUMMARY

### Technical Problems

However, the above-described secondary battery in JP 2020-095836A and the above-described battery in JP 2004-031263A have problems that even though it is necessary to release gas out of the battery case when the gas pressure or gas temperature in the battery case rises to a predetermined value or higher, the insulating member (the insulating film, the upper insulating plate) may obstruct the flow of gas to the safety valve. Thus, the safety valve is not allowed to operate properly.

The present disclosure has been made to address the above problems and has a purpose to provide a sealed secondary battery configured to ensure a flow passage of gas to a safety valve covered with an insulating member when the gas pressure or gas temperature in the battery case rises to a predetermined value or higher, facilitating proper operation of the safety valve.

### Means of Solving the Problems

(1) To achieve the above-mentioned purpose, one aspect of the present disclosure provides a sealed secondary battery comprising: a battery case; an electrode body hermetically housed in the battery case; an insulating member interposed between the battery case and the electrode body; and a safety valve placed in the battery case at a position facing the insulating member, and configured to release gas out of the battery case when a pressure or temperature of the gas in the battery case rises to a predetermined value or higher, wherein the safety valve includes a valve part that can be opened, and a valve-part supporting portion that annularly supports an outer circumferential portion of the valve part and is connected to the battery case, and the valve-part supporting portion has a case inner surface located on an inside of the battery case relative to the valve part, the case inner surface being provided with a gas-passage forming portion that forms a gas passage communicating toward the valve part between the insulating member and the valve-part supporting portion when the insulating member is pushed toward the valve part by the gas.

(2) In the secondary battery described in (1), the gas-passage forming portion may be provided with a recessed groove formed in the case inner surface of the valve-part supporting portion.

(3) In the secondary battery described in (1), the gas-passage forming portion may be provided with a projecting portion formed on the case inner surface of the valve-part supporting portion.

(4) In the secondary battery described in any one of (1) to (3), the valve-part supporting portion may be a resin valve-part supporting portion made of thermoplastic resin.

(5) In the secondary battery described in any one of (1) to (4), the valve part may be formed of a member with a lower tensile strength than a tensile strength of the battery case, and the valve-part supporting portion may be connected to the battery case via an annular member 112 made of the same material as the battery case.

### BRIEF DESCRIPTION OF THE DRAWINGS

FIG. 1 is a schematic cross-sectional view of a secondary battery in one aspect of an embodiment;

FIG. 2 is an enlarged cross-sectional view of a part A in FIG. 1, illustrating one opened state of a valve part;

FIG. 3 is an enlarged cross-sectional view of the part A in FIG. 1, illustrating another opened state of the valve part;

FIG. 4 is an enlarged cross-sectional view of the part A in FIG. 1, illustrating yet another opened state of the valve part;

FIG. 5 is a perspective view of a safety valve and an annular member joined to a valve-part supporting portion of the safety valve of the secondary battery shown in FIG. 1, viewed from case inside;

FIG. 6 is a cross-sectional view taken along a line B-B in FIG. 5;

FIG. 7 is a perspective view of a safety valve and an annular member joined to a valve-part supporting portion of the safety valve in a first modified example of the secondary battery shown in FIG. 1, viewed from case inside;

FIG. 8 is a perspective view of a safety valve and an annular member joined to a valve-part supporting portion of the safety valve in a second modified example of the secondary battery shown in FIG. 1, viewed from case inside; and

FIG. 9 is an enlarged cross-sectional view of the part A of the secondary battery in FIG. 1, illustrating an opened state of a safety valve in a third modified example.

### DETAILED DESCRIPTION OF THE EXEMPLARY EMBODIMENTS

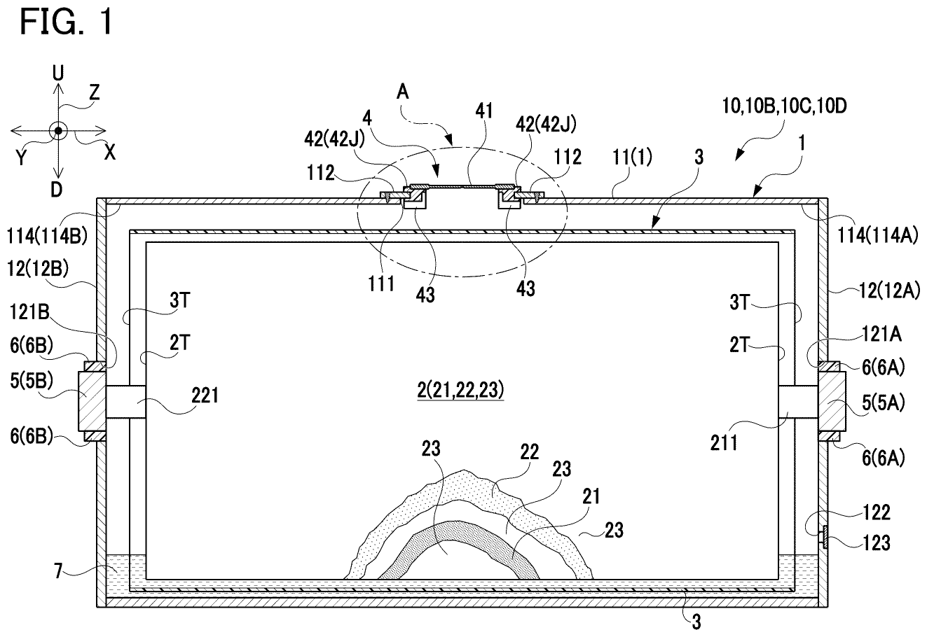

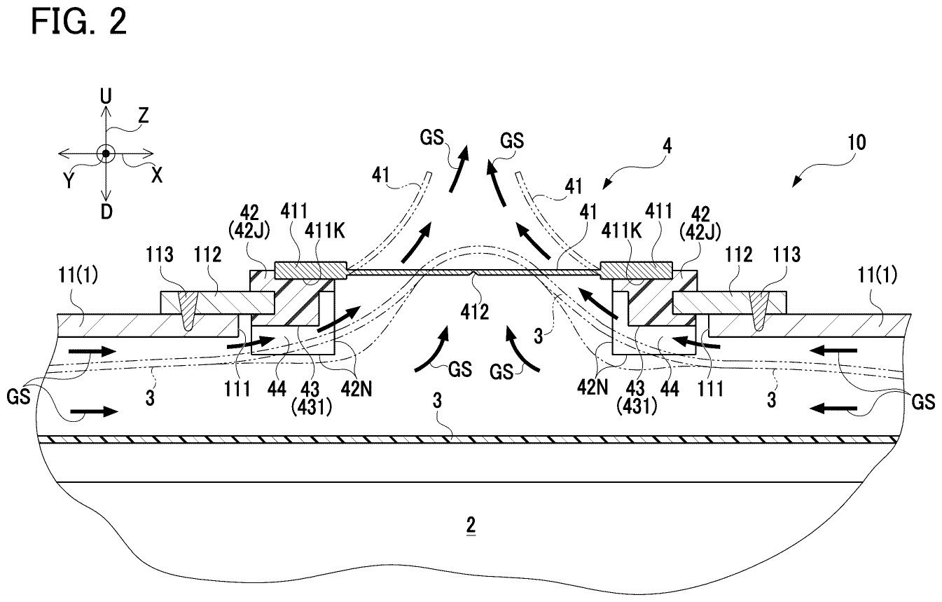

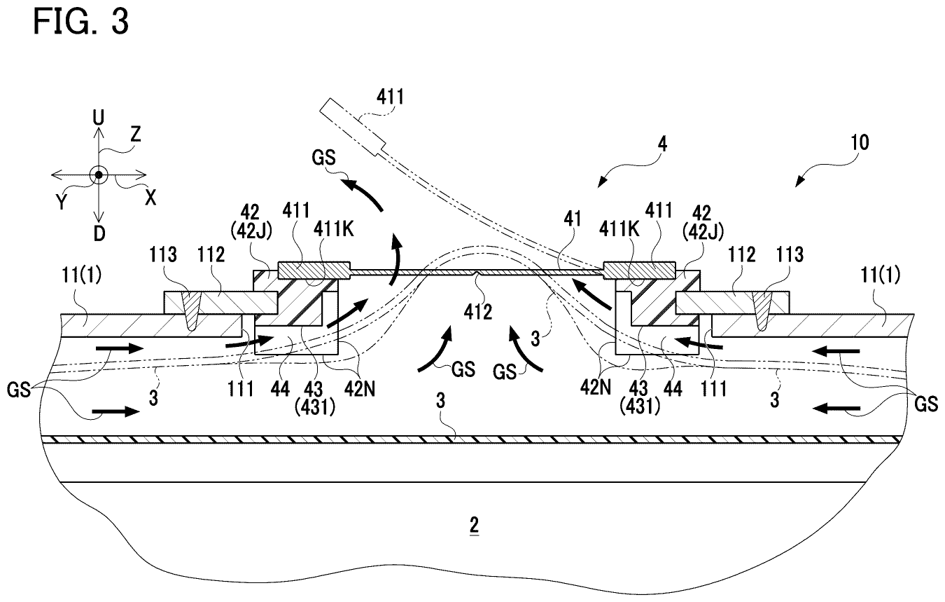

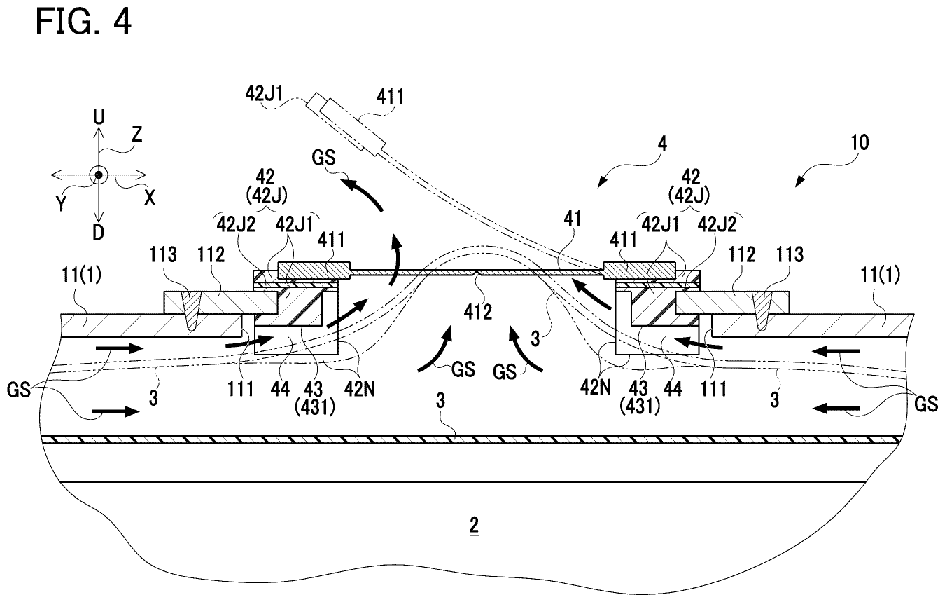

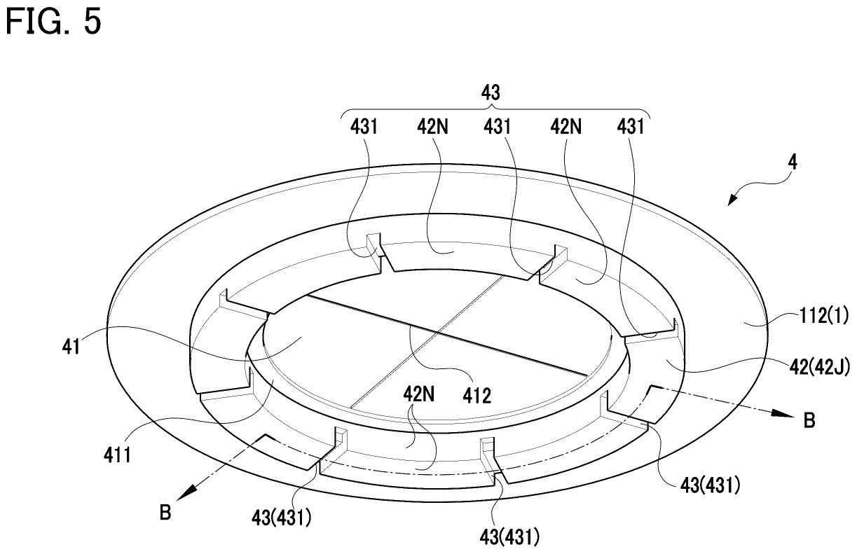

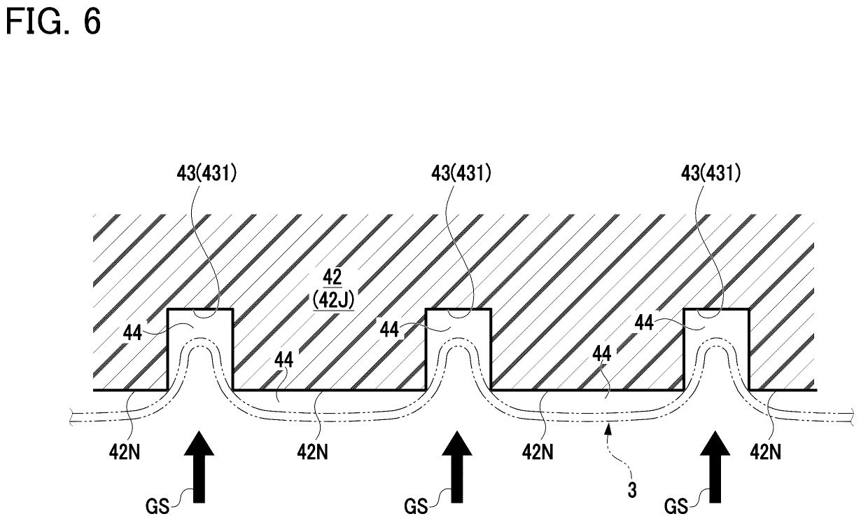

A detailed description of an embodiment of a secondary battery of this disclosure will now be given referring to the accompanying drawings. FIG. 1 is a schematic cross-sectional view of a secondary battery in one aspect of the embodiment. FIG. 2 is an enlarged cross-sectional view of a part A in FIG. 1, illustrating one opened state of a valve part. FIG. 3 is an enlarged cross-sectional view of the part A in FIG. 1, illustrating another opened state of the valve part. FIG. 4 is an enlarged cross-sectional view of the part A in FIG. 1, illustrating yet another opened state of the valve part. FIG. 5 is a perspective view of a safety valve and an annular member joined to a valve-part supporting portion of the safety valve of the secondary battery shown in FIG. 1, viewed from the inside of the battery case 1, which will be also referred to as “case inside”. FIG. 6 is a cross-sectional view taken along a line B-B in FIG. 5. Specifically, FIG. 6 is a partial cross-sectional view of an intermediate portion between on an inner peripheral side and an outer peripheral side of the valve-part supporting portion, cut in a circular arc form, as indicated by the line B-B, and its cut surface is viewed from the inner peripheral side in a horizontal direction. In FIGS. 1 to 4 and other figures, the direction X indicates a long-side direction of the battery case, the direction Y indicates a short-side direction (i.e., a width direction) of the battery case, and the direction Z indicates a vertical direction of the battery case. Further, an arrow U indicates the upper side and an arrow D indicates the lower side of the battery case 1.

The secondary battery 10 in the present embodiment is a sealed secondary battery including a battery case 1, an electrode body 2 hermetically housed in the battery case 1, an insulating member 3 interposed between the battery case 1 and the electrode body 2, and a safety valve 4 provided in the battery case 1 at a position facing the insulating member 3 to release gas GS out of the battery case 1 when the pressure or temperature of the gas GS in the battery case 1 rises to a predetermined value or higher, as shown in FIGS. 1 to 6.

Here, the battery case 1 includes a prismatic case body 11 having rectangular opening portions 114 (114A, 114B) on both ends in the long-side direction (the direction X), and plate-like lid members 12 (12A, 12B) closing the corresponding opening portions 114 (114A, 114B) of the case body 11. The battery case 1 may be made of, for example, stainless steel (e.g., JIS: SUS304) having superior pressure resistance, but the material of the battery case 1 is not limited thereto. The case body 11 and the lid members 12 are made of the same metal material and joined in a watertight manner by laser welding or other technique. The predetermined value of gas pressure is for example a reference value determined from the amount of deformation, etc. of the battery case 1, and the predetermined value of gas temperature is for example a reference value determined from a melting point, etc. of the insulating member 3. The shape of the battery case 1 is not limited to the above-mentioned one, and the battery case may be composed of a bottomed prismatic case body 11 having a single opening and a lid member that closes the opening.

In the battery case 1, the electrode body 2 formed of a positive electrode 21 and a negative electrode 22 with separators 23 interposed therebetween is hermetically sealed. Here, the electrode body 2 is configured such that the positive electrode 21 and the negative electrode 22, each of which has a strip-shape, are stacked with the separators 23 interposed therebetween and wound together in a direction perpendicular to the long-side direction (the direction X), and flattened under pressure in the short-side direction (the direction Y). Therefore, at each end edge 2T of the electrode body 2 in the long-side direction (the direction X), the end portion of the positive electrode 21, the end portion of the negative electrode 22, and the end portion of the separator 23 are open. Therefore, in the even that a short circuit or the like occurs between the positive electrode 21 and the negative electrode 22, high-temperature gas GS and others issue mainly from the end edges 2T of the electrode body 2 in the long-side direction (the direction X).

To ensure the electrical insulation between the battery case 1 and the electrode body 2, furthermore, the insulating member 3 made of an insulating film is interposed between the battery case 1 and the electrode body 2. The insulating member 3 is formed in a tubular shape that is longer than the electrode body 2 in the long-side direction (the direction X) and opens at both end edges 3T in the long-side direction (the direction X). Further, high-temperature gas GS and others issued from the end edges 2T of the electrode body 2 in the long-side direction (the direction X) will flow separately into the battery case 1 side and the electrode body 2 side, which are separated by the insulating member 3, and move toward the safety valve 4. Here, the insulating member 3 opens in the entire end edges 3T on both sides in the long-side direction, but the end edges 3T do not necessarily need to open over its entire area, and may open in only an area near a current collecting terminal 5 and a liquid inlet 122 which are mentioned later may be opened. The insulating member 3 may be made of for example polypropylene (PP) resin, and others.

In the lid members 12, the current collecting terminals 5 electrically connected to current collecting foils of the electrode body 2 are fixed in a watertight matter via insulating resin portions 6. The insulating resin portions 6 may be made of for example polyphenylene sulfide (PPS) and others. In one of the lid members 12, i.e., a lid member 12A shown in FIG. 1, a current collecting terminal 5 (5A) for positive electrode, connected to a tab of a current collecting foil 211 of the positive electrode 21, is inserted in a through hole 121A and fixed via the insulating resin portion 6 (6A). In the other lid member 12, i.e., a lid member 12B shown in FIG. 1, a current collecting terminal 5 (5B) for negative electrode, connected to a tab of a current collecting foil 221 of the negative electrode 22, is inserted in a through hole 121B and fixed via the insulating resin portion 6 (6B). The one lid member 12 (12A) is formed with the liquid inlet 122 through which an electrolyte 7 is poured into the case body 11, and the liquid inlet 122 is closed by a stopper 123 after the electrolyte 7 is poured.

The case body 11 is formed, in its upper end portion, with an insertion hole 111 for the safety valve 4. The safety valve 4 is provided with an openable valve part 41 and a valve-part supporting portion 42 formed in a ring shape, which annularly supports the outer circumferential portion 411 of the valve part 41 and is connected to the battery case 1 (112). The outer circumferential portion 411 of the valve part 41 has a thicker thickness than the inner circumferential portion of the valve part 41. A lower end portion 411K of the outer circumferential portion 411 is fixedly embedded in the upper end portion of the valve-part supporting portion 42. Further, the inner circumferential portion of the valve part 41 relative to the outer circumferential portion 411 is formed with V-grooves 412 for cleavage, which intersect in a cross pattern. The pattern of the V-grooves 412 shown in FIG. 5 is a mere example and may be any pattern other than that shown in FIG. 5. Here, the safety valve 4 has a circular shape as a whole, but it is not limited thereto, and may have an elliptic or oval shape, for example.

The lower portion of the valve-part supporting portion 42 is inserted in the insertion hole 111 of the battery case 1 (the case body 11) and protrudes to the case inside relative to the battery case 1. The outer peripheral portion of the valve-part supporting portion 42 is connected to an annular member 112 of the battery case 1. The annular member 112 is formed of a metal plate (e.g., a stainless steel plate), which is the same material as the battery case 1. Further, the annular member 112 is welded to the case body 11 via a welded portion 113 continuously formed around the outer circumference of the insertion hole 111. Thus, this annular member 112 is a part of the battery case 1. The welded portion 113 may be formed by laser welding, for example.

In the valve-part supporting portion 42, a case inner surface 42N located on the case inside relative to the valve part 41 is provided with gas-passage forming portions 43 that form gas passages 44 between the insulating member 3 and the valve-part supporting portion 42 when the insulating member 3 is pushed out toward the valve part 41 by gas GS whose gas pressure or gas temperature rises to a predetermined value or higher in the battery case 1. The gas-passage forming portions 43 form gas passages 44 that communicate, or extend, toward the valve part 41. Thus, when the gas pressure or gas temperature in the battery case 1 rises to the predetermined value or higher, the gas GS flowing on the battery case 1 side relative to the insulating member 3 is supplied toward the valve part 41 through the gas passages 44 formed between the insulating member 3 pushed out toward the valve part 41 by gas GS on the electrode body 2 side and the valve-part supporting portion 42. The gas-passage forming portions 43 may be formed in multiple positions spaced at predetermined intervales, each extending from the outer peripheral side to the inner peripheral side, along the case inner surface 42N (namely, an inner peripheral surface and a bottom surface) of the valve-part supporting portion 42 annularly formed. In this case, more than one gas passage 44 is formed extending from the outer peripheral side of the valve-part supporting portion 42 toward the valve part 41.

The valve part 41 is opened by the gas GS supplied to the valve part 41 through the gas passages 44, thus allowing the gas GS to release out of the battery case 1 via the safety valve 4 with the valve part 41 opened. Consequently, in the sealed secondary battery 10 configured as above, when the gas pressure or gas temperature in the battery case 1 rises to the predetermined value or higher, the gas passages 44 are ensured to supply gas GS to the safety valve 4 covered by the insulating member 3, facilitating proper operation of the safety valve 4.

The gas-passage forming portions 43 may be formed in various shapes. Here, the gas-passage forming portions 43 are each provided with a recessed groove 431 formed in the case inner surface 42N of the valve-part supporting portion 42. Each of the recessed grooves 431 has a U-shaped cross-section Further, each recessed groove 431 has an L-shaped cross-section in a radial direction of the valve-part supporting portion 42, which is bent to continuously extend in the vertical direction (the direction Z) and the radial direction, from the outer peripheral side to the inner peripheral side of the case inner surface 42N of the valve-part supporting portion 42. The recessed grooves 431 are arranged at equal intervals in the circumferential direction of the valve-part supporting portion 42. Therefore, when the insulating member 3 is pushed toward the valve part 41 by the gas GS in the battery case 1, as shown in FIGS. 2 and 6, some portions of the insulating member 3 enter in the recessed grooves 431, creating corrugated folds in the insulating member 3 covering the safety valve 4.

In this case, gaps tend to be generated between the insulating member 3 and each recessed groove 431 and between the insulating member 3 and the case inner surface 42N of the valve-part supporting portion 42. Those gaps facilitate formation of the gas passages 44 through which the gas GS in the battery case 1 flows toward the valve part 41. As a result, as shown in FIG. 2, the gas GS supplied through the gas passages 44 toward the valve part 41 cleaves the V-grooves 412 of the valve part 41, and hence the valve part 41 is opened. Then, the gas GS is released out of the battery case 1 through the safety valve 4 with the valve part 41 opened.

The valve-part supporting portion 42 may be a resin valve-part supporting portion 42 made of thermoplastic resin. The valve part 41 is joined to the resin valve-part supporting portion 42J by insert molding. The resin valve-part supporting portion 42J may be made for example polyphenylene sulfide (PPS). In this case, when the gas temperature in the battery case 1 rises to the predetermined value or higher before the gas pressure increases to the predetermined value or more, a joined portion of the rein valve-part supporting portion 42J to the valve part 41 softens or melts, allowing the outer circumferential portion 411 of the valve part 41 to separate from the resin valve-part supporting portion 42J before the V-grooves 412 of the valve part 41 are broken, or cleaved, as shown in FIG. 3. Thus, the valve part 41 can be stably opened even when the gas pressure increases slowly and therefore the amount of gas GS to be supplied through the gas passages 44 toward the valve part 41 is small.

The resin valve-part supporting portion 42J may be made of a combination of different resin materials having different melting points as shown in FIG. 4. For example, the rein valve-part supporting portion 42J may be composed of first resin portions 42J1 with a high melting point, which are joined to the valve part 41 and the annular member 112, and a second resin portion 42J2 with a lower melting point than the first resin portions 42J1. The second resin portion 42J2 is held between the first resin portions 42J1 stacked together. For example, the first resin portions 42J1 may be made of polyphenylene sulfide (PPS) whose melting point is about 290° C. and the second resin portion 42J2 may be made of polypropylene (PP) whose melting point is about 170° C.

In this case, when the gas temperature rises to the melting point or softening temperature of the second resin portion 42J2, as shown in FIG. 4, the outer circumferential portion 411 of the valve part 41 can separate from the rein valve-part supporting portion 42J as shown in FIG. 4. Thus, the valve part 41 can be stably opened at lower temperatures than in the rein valve-part supporting portion 42J shown in FIG. 3, even when the amount of gas GS supplied toward the valve part 41 through the gas passages 44 is small.

The secondary battery 10 in the present embodiment may be configured such that the valve part 41 is formed of a component having a lower tensile strength than a tensile strength of the battery case 1, and the valve-part supporting portion 42 is connected to the battery case 1 via the annular member 112 made of the same material as the battery case 1. For example, the valve part 41 may be made of annealed aluminum (tensile strength: about 70 to 100 N/mm²) and the battery case 1 and the annular member 112 may be made of austenitic stainless steel (tensile strength: about 590 N/mm²).

In this case, while the pressure resistance performance of the battery case 1 against the gas GS is enhanced, the valve part 41 with a low tensile strength can be stably opened even when the amount of gas GS supplied toward the valve part 41 through the gas passages 44 formed between the insulating member 3 and the valve-part supporting portion 42 is small during gas pressure increase.

In a lithium ion secondary battery, which is one example of the secondary battery 10 of the present embodiment, the current collecting foil 211 of the positive electrode 21 may be for example an aluminum foil and an active material applied thereon may be for example lithium transition metal oxide (LiNi_{1/3}Co_{1/3}Mn_{1/3}O₂, LiNiO₂, etc.). The current collecting foil 221 of the negative electrode 22 may be for example a copper foil and an active material applied thereon may be for example graphite, hard carbon, soft carbon, etc. Further, the separators 23 may be porous sheets made of for example polypropylene resin, polyethylene resin, etc. The electrolyte 7 may be a well-known non-aqueous electrolyte. The current collecting terminal 5A for positive electrode is made of for example aluminum and the current collecting terminal 5B for negative electrode is made of for example copper.

The secondary battery 10 in the present embodiment may be manufactured by the following procedures. Specifically, the electrode body 2 wrapped with the insulating member 3 is put in the case body 11 of the battery case 1, the current collecting foils 211 and 221 of the electrode body 2 are connected to the current collecting terminals 5 (5A, 5B) fixed to the lid member 12, the opening portions 114 of the case body 11 are closed by the lid members 12, and then the electrolyte 7 is poured. Subsequently, the secondary battery 10 is completed after initial charging, aging, etc.

### MODIFIED EXAMPLES

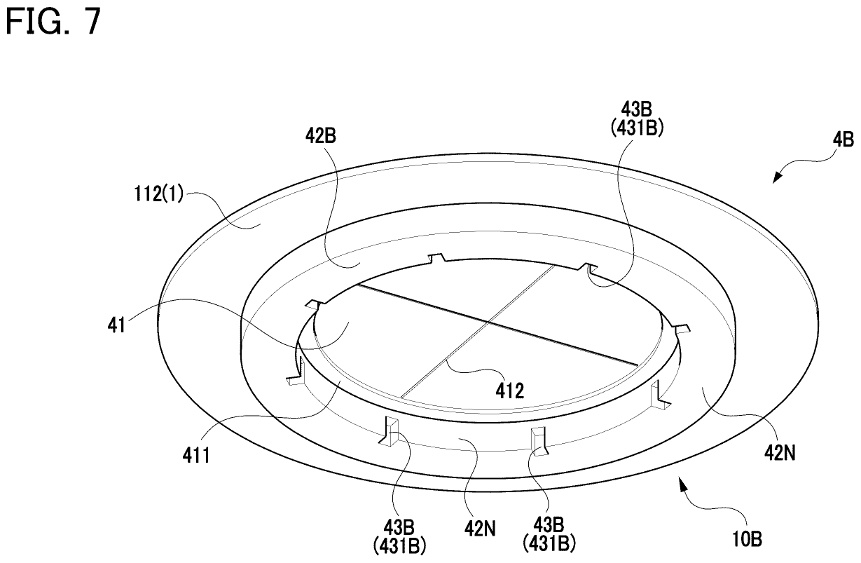

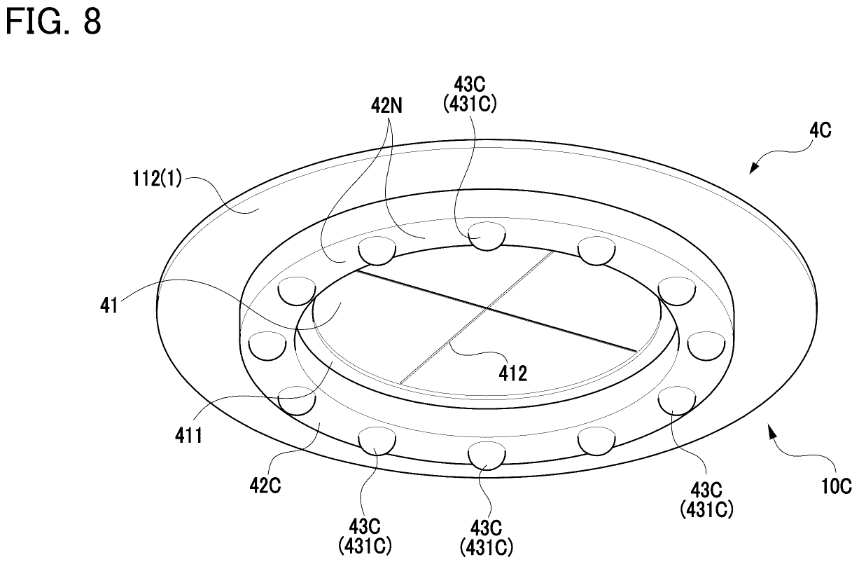

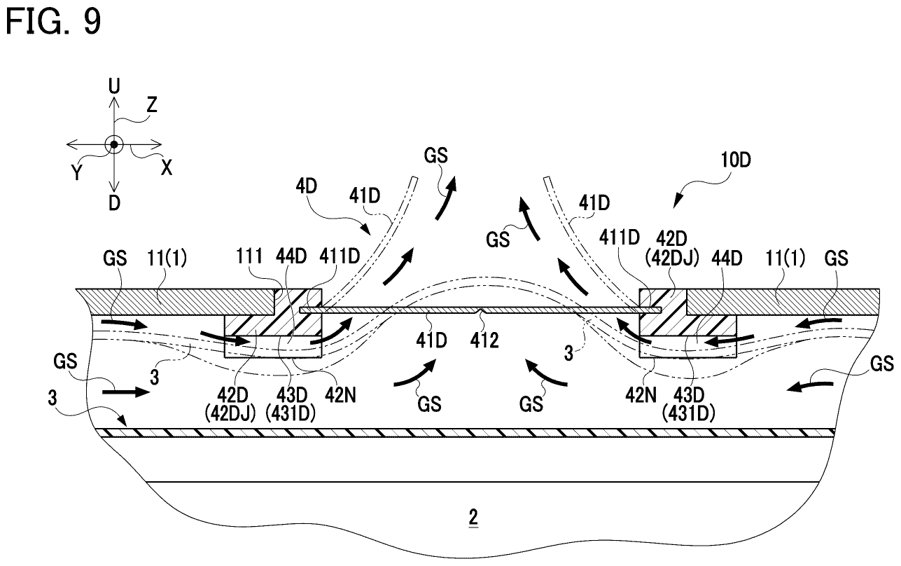

The foregoing embodiments are mere examples and give no limitation to the present disclosure. The present disclosure may be embodied in other specific forms without departing from the essential characteristics thereof. FIG. 7 is a perspective view of a safety valve and an annular member joined to a valve-part supporting portion of the safety valve in a first modified example of the secondary battery shown in FIG. 1, viewed from case inside. FIG. 8 is a perspective view of a safety valve and an annular member joined to a valve-part supporting portion of the safety valve in a second modified example of the secondary battery shown in FIG. 1, viewed from case inside. FIG. 9 is an enlarged cross-sectional view of the part A of the secondary battery in FIG. 1, illustrating an opened state of a safety valve in a third modified example.

In the secondary battery 10 in the present embodiment, as shown in FIGS. 2 to 5, the gas-passage forming portions 43 formed in the case inner surface 42N of the valve-part supporting portion 42 are the recessed grooves 431 each having an L-shaped cross-section in the radial direction, which is bent to continuously extend in the vertical direction (the direction Z) and the radial direction, from the outer peripheral side to the inner peripheral side of the case inner surface 42N of the valve-part supporting portion 42, but it is not limited thereto.

For example, as in a secondary battery 10B in the first modified example shown in FIG. 7, gas-passage forming portions 43B formed in a valve-part supporting portion 42B of a safety valve 4B may be recessed grooves 431B that extend in straight line in the vertical direction (the direction Z) on only the inner peripheral side of the case inner surface 42N of the valve-part supporting portion 42B. Also in this case, when the insulating member 3 is pushed toward the valve part 41 by the gas GS in the battery case 1, some portions of the insulating member 3 enter in the recessed grooves 431B, forming corrugated folds in the insulating member 3 covering the safety valve 4. Thus, gaps tend to be generated between the insulating member 3 and each recessed groove 431B and between the insulating member 3 and the case inner surface 42N of the valve-part supporting portion 42B. Those gaps facilitate formation of the gas passages 44 through which the gas GS in the battery case 1 flows toward the valve part 41.

Alternatively, as in a secondary battery 10C in the second modified example shown in FIG. 8, gas-passage forming portions 43C formed on the case inner surface 42N of a valve-part supporting portion 42C of a safety valve 4C may be projecting portions 431C formed on the case inner surface 42N of the valve-part supporting portion 42C. The projecting portions 431C protrude downward in the vertical direction (the direction Z). Also in this case, when the insulating member 3 is pushed toward the valve part 41 by the gas GS in the battery case 1, some portions of the insulating member 3 are pushed downward by the projecting portions 431C, forming corrugated folds in the insulating member 3 covering the safety valve 4. Thus, gaps tend to be generated between the insulating member 3 and the projecting portions 431C and between the insulating member 3 and the case inner surface 42N of the valve-part supporting portion 42C. Those gaps facilitate formation of the gas passages 44 through which the gas GS in the battery case 1 flows toward the valve part 41. The projecting portions 431C each have a semi-spherical shape in FIG. 8, but may have a prismatic shape or a triangular pyramid shape, for example. The gas-passage forming portions 43C formed on the case inner surface 42N of the valve-part supporting portion 42C may include both the recessed grooves 431 and the projecting portions 431C.

The secondary battery 10 in the present embodiment is configured such that the annular member 112 of the battery case 1 is connected to the outer peripheral portion of the valve-part supporting portion 42 of the safety valve 4, but it is not limited thereto. For example, as in a secondary battery 10D in a third modified example shown in FIG. 9, the outer peripheral portion of a valve-part supporting portion 42D of a safety valve 4D may be directly connected to the battery case 1 (i.e., the case body 11). The gas-passage forming portions 43D formed in the case inner surface 42N of the valve-part supporting portion 42D may be provided with recessed grooves 431D formed in the case inner surface 42N of the valve-part supporting portion 42D. Also in this case, when the insulating member 3 is pushed toward the valve part 41D by the gas GS in the battery case 1, some portions of the insulating member 3 enter in the recessed grooves 431D, forming corrugated folds in the insulating member 3 covering the safety valve 4. Thus, gaps tend to be generated between the insulating member 3 and the recessed grooves 431D and between the insulating member 3 and the case inner surface 42N of the valve-part supporting portion 42D. Those gaps facilitate formation of gas passages 44D through which the gas GS in the battery case 1 flows toward the valve part 41D. The valve-part supporting portion 42D is a resin valve-part supporting portion 42DJ made of thermoplastic resin. The battery case 1 (i.e., the case body 11) and the outer circumferential portion 411D of the valve part 41D are joined to the resin valve-part supporting portion 42DJ by insert molding.

Reference Signs List

| | |
|---|---|
| 1 | Battery case |
| 2 | Electrode body |
| 3 | Insulating member |
| 4, 4B, 4C, 4D | Safety valve |
| 5, 5A, 5B | Current collecting terminal |
| 10, 10B, 10C, 10D | Secondary battery |
| 41, 41D | Valve part |
| 42, 42B, 42C, 42D | Valve-part supporting portion |
| 42N | Case inner surface |
| 42J, 42DJ | Resin valve-part supporting portion |
| 43, 43B, 43C, 43D | Gas-passage forming portion |
| 44, 44D | Gas passage |
| 112 | Annular member |
| 411, 411D | Outer circumferential portion |
| 431, 431B, 431D | Recessed groove |
| 431C | Projecting portion |
| GS | Gas |

What is claimed is:

1. A sealed secondary battery comprising:
a battery case;
an electrode body hermetically housed in the battery case;
an insulating member interposed between the battery case and the electrode body; and
a safety valve placed in the battery case at a position facing the insulating member, and configured to release gas out of the battery case when a pressure or temperature of the gas in the battery case rises to a predetermined value or higher,
wherein the safety valve includes a valve part that can be opened, and a valve-part supporting portion that annularly supports an outer circumferential portion of the valve part and is connected to the battery case, and
the valve-part supporting portion has a case inner surface located on an inside of the battery case relative to the valve part, the case inner surface being provided with a gas-passage forming portion that forms a gas passage communicating toward the valve part between the insulating member and the valve-part supporting portion when the insulating member is pushed toward the valve part by the gas.

2. The secondary battery according to claim 1, wherein the gas-passage forming portion is provided with a recessed groove formed in the case inner surface of the valve-part supporting portion.

3. The secondary battery according to claim 1, wherein the gas-passage forming portion is provided with a projecting portion formed on the case inner surface of the valve-part supporting portion.

4. The secondary battery according to claim 1, wherein the valve-part supporting portion is a resin valve-part supporting portion made of thermoplastic resin.

5. The secondary battery according to claim 2, wherein the valve-part supporting portion is a resin valve-part supporting portion made of thermoplastic resin.

6. The secondary battery according to claim 3, wherein the valve-part supporting portion is a resin valve-part supporting portion made of thermoplastic resin.

7. The secondary battery according to claim 1, wherein
the valve part is formed of a member with a lower tensile strength than a tensile strength of the battery case, and
the valve-part supporting portion is connected to the battery case via an annular member made of the same material as the battery case.

8. The secondary battery according to claim 2, wherein
the valve part is formed of a member with a lower tensile strength than a tensile strength of the battery case, and
the valve-part supporting portion is connected to the battery case via an annular member made of the same material as the battery case.

9. The secondary battery according to claim 3, wherein
the valve part is formed of a member with a lower tensile strength than a tensile strength of the battery case, and
the valve-part supporting portion is connected to the battery case via an annular member made of the same material as the battery case.

10. The secondary battery according to claim 4, wherein
the valve part is formed of a member with a lower tensile strength than a tensile strength of the battery case, and
the valve-part supporting portion is connected to the battery case via an annular member made of the same material as the battery case.

11. The secondary battery according to claim 5, wherein
the valve part is formed of a member with a lower tensile strength than a tensile strength of the battery case, and
the valve-part supporting portion is connected to the battery case via an annular member made of the same material as the battery case.

12. The secondary battery according to claim 6, wherein
the valve part is formed of a member with a lower tensile strength than a tensile strength of the battery case, and
the valve-part supporting portion is connected to the battery case via an annular member made of the same material as the battery case.
